(19) United States
(12) Patent Application Publication
(10) Pub. No.: US 2024/0210305 A1
(43) Pub. Date: Jun. 27, 2024

(54) LIQUID HOUSING CONTAINER AND MANUFACTURING METHOD FOR LIQUID HOUSING CONTAINER

(71) Applicant: KYOCERA Corporation

(72) Inventor: Hiroshi HAMASHIMA, Hikone-shi, Shiga (JP)

(21) Appl. No.: 18/272,501

(22) PCT Filed: Jan. 25, 2022
(86) PCT No.: PCT/JP2022/002710

§ 371 Date: Jul. 14, 2023

(30) Foreign Application Priority Data
Jan. 26, 2021 (JP) 2021-010642

(51) Int. Cl. G01N 21/03; B01L 3/00

(52) U.S. Cl. CPC G01N 21/03; B01L 3/5082; B01L 2300/0858; G01N 2021/0389

(57) ABSTRACT

In an embodiment of the present disclosure, a liquid housing container includes a frame-like distal end portion; a tubular portion including a first sidewall that introduces light for measurement, a second sidewall that guides the light outward, and a third sidewall and a fourth sidewall located between the first sidewall and the second sidewall and connecting the first sidewall and the second sidewall, the tubular portion being connected to the distal end portion on a bottom side of the distal end portion; and a base portion sealing a bottom side of the tubular portion. A cut level difference Rδc1 in a roughness curve of an inner wall surface of the first sidewall and an inner wall surface of the second sidewall is larger than a cut level difference Rδc2 in a roughness curve of an inner wall surface of a sidewall of the distal end portion. The cut level difference represents a difference between a cut level at a load length ratio of 25% in a roughness curve and a cut level at a load length ratio of 75% in the roughness curve.

### TECHNICAL FIELD

The present disclosure relates to a liquid housing container such as a reaction cell and a manufacturing method for the liquid housing container.

### BACKGROUND OF INVENTION

Reaction cells used in automatic analyzers are usually made of transparent resin, and repeatedly undergo sample measurement and washing. Such repeated use of reaction cells causes carry-over and cross-contamination. In order to control carry-over, reaction cells are preferably made disposable. However, since characteristics of samples are measured using light, reaction cells are required to have strict accuracy. The manufacturing cost of reaction cells is not low enough to make them disposable. Therefore, reaction cells are repeatedly used for economic reasons, and how to reduce the carry-over is a problem.

In order to solve this problem, Patent Document 1 proposes a rectangular tubular reaction cell formed of a polyolefin-based resin, which is a hydrophobic resin, or having an inner surface coated with this resin.

### CITATION LIST

### Patent Literature

Patent Document 1: JP 6-323986 A

### SUMMARY

### Problem to be Solved

In an embodiment of the present disclosure, a liquid housing container includes: a distal end portion that is frame-like; a tubular portion including a first sidewall that introduces a light for measurement, a second sidewall that guides the light outward, and a third sidewall and a fourth sidewall located between the first sidewall and the second sidewall and connecting the first sidewall and the second sidewall, the tubular portion being connected to the distal end portion on a bottom side of the distal end portion; and a base portion sealing a bottom side of the tubular portion, wherein a cut level difference is a difference between a cut level at a load length ratio of 25% in a roughness curve and a cut level at a load length ratio of 75% in the roughness curve, and a cut level difference Rδc1 in a roughness curve of an inner wall surface of the first sidewall and an inner wall surface of the second sidewall is larger than a cut level difference Rδc2 in a roughness curve of an inner wall surface of a sidewall of the distal end portion.

In another embodiment of the present disclosure, a liquid housing container includes: a tubular portion including a first sidewall that introduces a light for measurement, a second sidewall that guides the light outward, and a third sidewall and a fourth sidewall located between the first sidewall and the second sidewall and connecting the first sidewall and the second sidewall, the tubular portion being connected to the distal end portion on a bottom side of the distal end portion; and a base portion sealing a bottom side of the tubular portion, wherein a cut level difference is a difference between a cut level at a load length ratio of 25% in a roughness curve and a cut level at a load length ratio of 75% in a roughness curve, and a cut level difference Rδc1 in a roughness curve of an inner wall surface of the first sidewall and an inner wall surface of the second sidewall is larger than a cut level difference Rδc3 in a roughness curve of an inner wall surface of the third sidewall and an inner wall surface of the fourth sidewall.

In an embodiment of the present disclosure, a manufacturing method for the liquid housing container includes: adhering water to at least one of a first opposing surface facing the tubular portion of the distal end portion or a second opposing surface facing the distal end portion of the tubular portion, and at least one of a third opposing surface facing the base portion of the tubular portion or a fourth opposing surface facing the tubular portion of the base portion, respectively; causing the first opposing surface and the second opposing surface to face each other, and the third opposing surface and the fourth opposing surface to face each other; and applying pressure from a longitudinal direction and performing thermal treatment.

In another embodiment of the present disclosure, a manufacturing method for liquid housing container includes: adhering water to at least one of a third opposing surface facing the base portion of the tubular portion or a fourth opposing surface facing the tubular portion of the base portion; causing the third opposing surface and the fourth opposing surface to face each other; and applying pressure from a longitudinal direction and performing thermal treatment.

### BRIEF DESCRIPTION OF THE DRAWINGS

FIG. 1A is a perspective view illustrating a liquid housing container according to an embodiment of the present disclosure.

FIG. 1B is a cross-sectional view perpendicular to the axial direction of the tubular portion illustrated in FIG. 1A.

FIG. 2A is a perspective view illustrating a liquid housing container according to another embodiment of the present disclosure.

FIG. 2B is a cross-sectional view perpendicular to the axial direction of the tubular portion illustrated in FIG. 2A.

FIG. 3A is a perspective view illustrating a liquid housing container according to a still other embodiment of the present disclosure.

FIG. 3B is a cross-sectional view perpendicular to the axial direction of the tubular portion illustrated in FIG. 3A.

FIG. 4A is a perspective view illustrating a liquid housing container according to another embodiment of the present disclosure.

FIG. 4B is a cross-sectional view perpendicular to the axial direction of the tubular portion illustrated in FIG. 4A.

FIG. 5A is a perspective view illustrating a liquid housing container according to another embodiment of the present disclosure.

FIG. 5B is a cross-sectional view perpendicular to the axial direction of the tubular portion illustrated in FIG. 5A.

### DESCRIPTION OF EMBODIMENTS

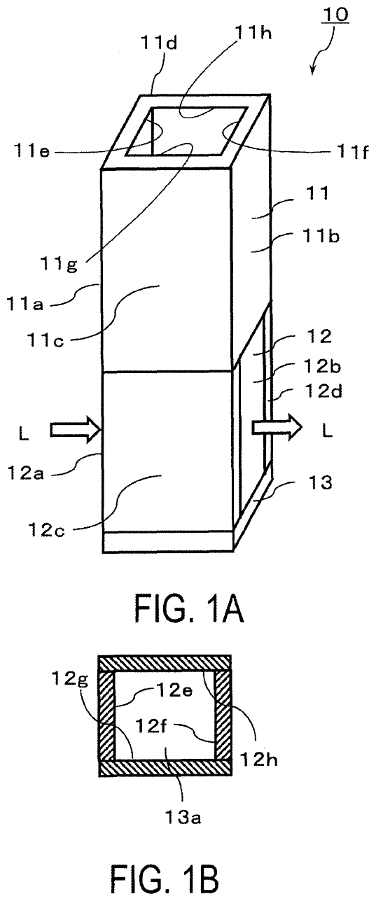

The liquid housing container according to embodiments of the present disclosure will be described with reference to FIGS. 1 to 5. A liquid housing container 10 according to the embodiments illustrated in FIGS. 1 to 3 includes a distal end portion 11, a tubular portion 12, and a base portion 13. The tubular portion 12 has a rectangular tubular shape. The tubular portion 12 includes a first sidewall 12a for introducing light L for measurement into test liquid, a second sidewall 12b for guiding the light L from the test liquid outward, and a third sidewall 12c and a fourth sidewall 12d located between the first sidewall 12a and the second sidewall 12b and connecting the first sidewall 12a and the second sidewall 12b. The first sidewall 12a, the second sidewall 12b, the third sidewall 12c, and the fourth sidewall 12d have inner wall surfaces 12e, 12f, 12g, and 12h, respectively.

The base portion 13 seals the bottom side of the tubular portion 12. The base portion illustrated in FIGS. 1 to 3 is a flat plate, but may be a curved plate that is convex or protruding toward the bottom side.

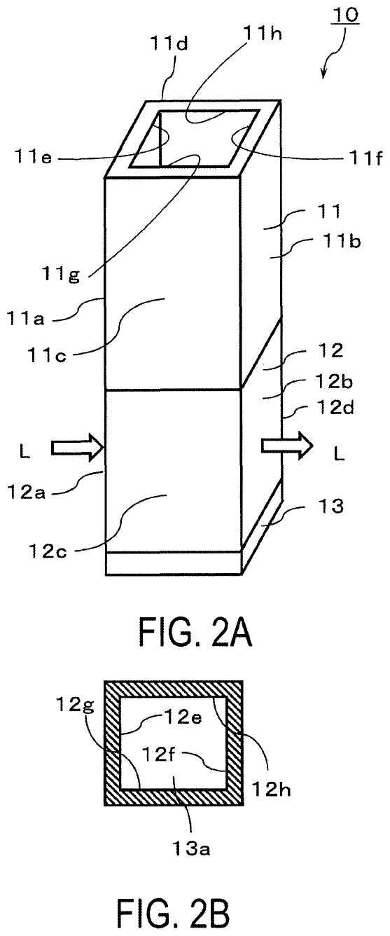

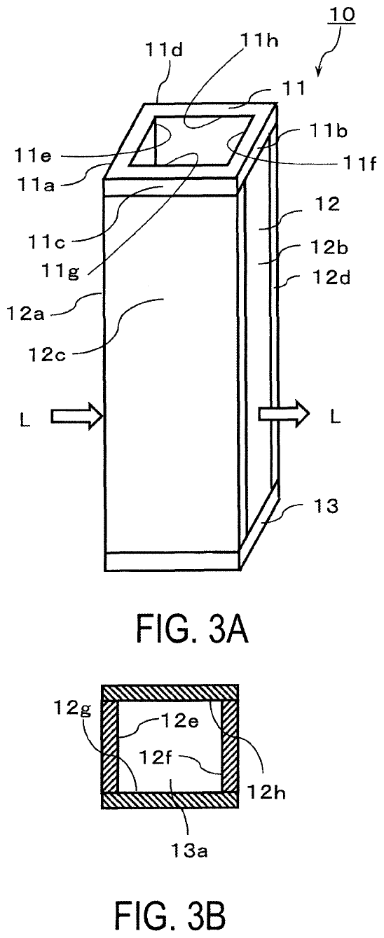

The distal end portion 11 has a shape of a frame provided with an opening portion. For example, the distal end portion 11 has a tubular shape as illustrated in FIGS. 1 and 2 or an annular shape as illustrated in FIG. 3. A sample and a reagent are supplied from the opening portion.

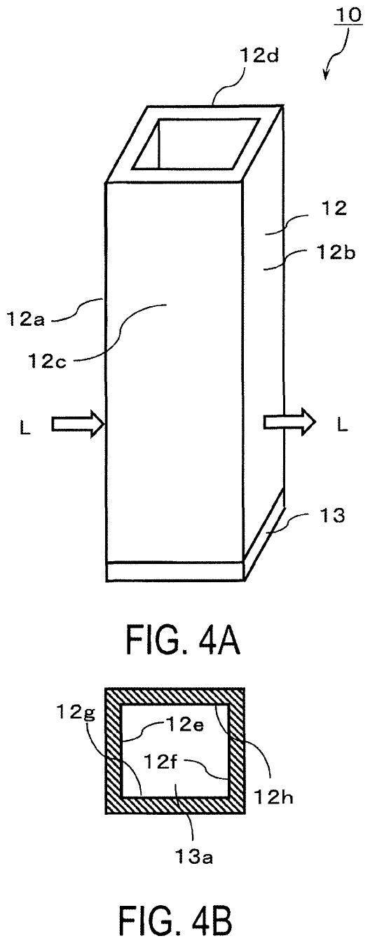

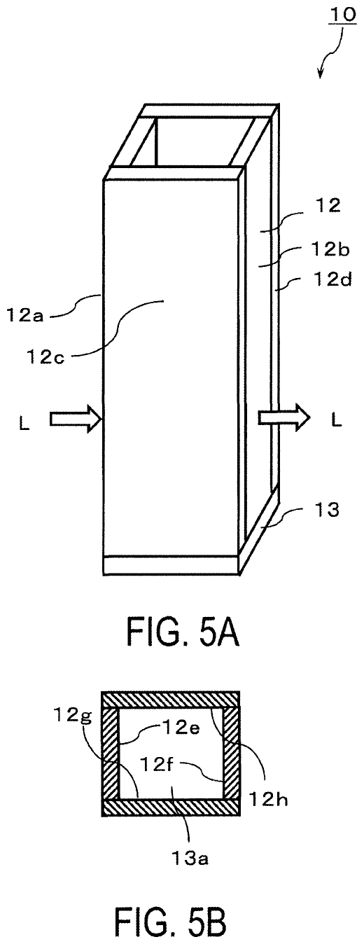

On the other hand, the liquid housing container illustrated in FIGS. 4 and 5 includes no distal end portion, and includes a tubular portion 12 having a rectangular tubular shape, and a base portion 13 for sealing the bottom side of the tubular portion 12. The sample and the reagent are supplied from the opening side of the tubular portion 12. The space formed by the tubular portion 12 and the base portion 13 illustrated in FIGS. 1 to 5 is a space in which the reagent and the sample are caused to react with each other.

The inner wall surfaces 12e, 12f, 12g, and 12h may be inclined toward an inner bottom surface 13a of the base portion 13, and the inclination may have a rounded shape.

The material of the tubular portion 12 is not limited, but for at least the first sidewall 12a and the second sidewall 12b, examples include sapphire or light-transmissive ceramic containing aluminum oxide or zirconium oxide as a main component. The third sidewall 12c and the fourth sidewall 12d may be formed of sapphire or the ceramic described above, but may be made of non-light-transmissive ceramic containing aluminum oxide or zirconium oxide as a main component for the reason of low cost. The tubular portion 12 may be integrally formed of sapphire, light-transmissive ceramic containing aluminum oxide or zirconium oxide as a main component, or the like, as illustrated in FIGS. 2 and 4.

In the present disclosure, the sapphire or ceramic used for the tubular portion 12 is referred to as the “first ceramic” for the purpose of convenience.

The size of the tubular portion 12 is not particularly limited. The size is set appropriately in accordance with a desired member. The width of each of the first sidewall 12a and the second sidewall 12b is, for example, not less than 4.5 mm and not more than 5.5 mm. The width of each of the third sidewall 12c and the fourth sidewall 12d is, for example, not less than 5.5 mm and not more than 6.5 mm. The thickness of each of the first sidewall 12a, the second sidewall 12b, the third sidewall 12c, and the fourth sidewall 12d is not less than 0.8 mm and not more than 1.2 mm.

In the liquid housing container 10 illustrated in FIGS. 1 to 3, the depth from the end surface on the opening side of the distal end portion 11 to the inner bottom surface 13a is not less than 29 mm and not more than 31 mm. In the liquid housing container 10 illustrated in FIGS. 4 and 5, the depth from the end surface on the opening side of the tubular portion 12 to the inner bottom surface 13a is not less than 29 mm and not more than 31 mm.

The material of the base portion 13 is not limited. Examples of the material of the base portion 13 include a material employed for the tubular portion 12. A main component of the tubular portion 12 may be the same material as a main component of the base portion 13. The material of the base portion 13 is preferably sapphire or ceramic as with the tubular portion 12. In the present disclosure, the sapphire or ceramic used for the base portion 13 is referred to as the “second ceramic” for the purpose of convenience. When ceramic is employed as a material of the tubular portion 12 and the base portion 13, the first ceramic and the second ceramic may be ceramics containing the same main component, or may be ceramics each containing a different main component.

The material of the distal end portion 11 is not limited either. Examples of the material of the distal end portion 11 include a material employed for the tubular portion 12. A main component of the distal end portion 11 may be same as a main component of the tubular portion 12. The material of the distal end portion 11 may be sapphire or ceramic as with the tubular portion 12.

Note that in the present disclosure, the main component refers to a component that accounts for 80 mass % or more of the total of 100 mass % of the components constituting the ceramic. The identification of each component contained in the ceramic may be performed with an X-ray diffractometer using a CuKα beam, and the content of each component may be determined, for example, with an inductively coupled plasma (ICP) emission spectrophotometer or a fluorescence X-ray spectrometer.

The inner wall surfaces 12e, 12f, 12g, and 12h of the tubular portion 12 and the inner bottom surface 13a of the base portion 13 are ground or polished into a shape corresponding to a desired member.

A cut level difference Rδc1 in a roughness curve of the inner wall surface 12e of the first sidewall 12a and the inner wall surface 12f of the second sidewall 12b is larger than a cut level difference Rδc2 in a roughness curve of the inner wall surfaces 11e, 11f, 11g, and 11h of the distal end portion 11. The cut level difference Rδc in a roughness curve is an index indicating a difference in the height direction between cut levels C (Rrm1) and C (Rrm2) that coincide with the respective load length ratios Rmr1 and Rmr2 in a roughness curve specified in JIS B 0601:2001, and a larger value indicates that the surface is more uneven and the contact angle of the surface with respect to the test liquid is smaller. That is, a larger value indicates that the inner wall surfaces 12e and 12f are more uneven than the inner wall surfaces 11e, 11f, 11g, and 11h of the distal end portion 11, and have smaller contact angles with respect to the test liquid.

In the present disclosure, the “cut level difference Rδc1” means a difference between a cut level at a load length ratio of 25% in the roughness curve of the inner wall surfaces 12e and 12f and a cut level at a load length ratio of 75% in the roughness curve. The “cut level difference Rδc2” means a difference between a cut level at a load length ratio of 25% in the roughness curve of the inner wall surfaces 11e, 11f, 11g, and 11h of the distal end portion 11 and a cut level at a load length ratio of 75% in the roughness curve. The “cut level difference Rδc3” means a difference between a cut level at a load length ratio of 25% in the roughness curve of the inner wall surfaces 12g and 12h and a cut level at a load length ratio of 75% in the roughness curve.

In the liquid housing container 10 illustrated in FIGS. 1 to 3, the cut level difference Rδc1 in the roughness curve of the inner wall surface 12e of the first sidewall 12a and the inner wall surface 12f of the second sidewall 12b is larger than the cut level difference Rδc2 in the roughness curve of the inner wall surfaces 11e, 11f, 11g, and 11h of the distal end portion 11. Therefore, the inner wall surfaces 12e and 12f are more uneven than the inner wall surfaces 11e, 11f, 11g, and 11h of the side walls of the distal end portion 11. With such a configuration, the inner wall surface 12e and the inner wall surface 12f have small contact angles with respect to the test liquid. Therefore, bubbles having large curvatures are less likely to adhere to the inner wall surface 12e and the inner wall surface 12f, and thus the measurement accuracy of the test liquid can be improved. On the other hand, the inner wall surfaces 11e, 11f, 11g, and 11h of the distal end portion 11 have large contact angles with respect to the test liquid, and thus wetting-up of the test liquid toward the end surface of the distal end portion 11 is controlled. Therefore, when a plurality of liquid housing containers are adjacent to each other, cross-contamination of the test liquid between the liquid housing containers is controlled, and the measurement accuracy of the test liquid can be improved.

When the first sidewall 12a and the second sidewall 12b are made of sapphire, the inner wall surface 12e and the inner wall surface 12f may be a (11−20) plane, a (10−10) plane, or a (0001) plane. This is because these planes have smaller contact angles with respect to the test liquid than other lattice planes.

As long as the cut level difference Rδc 1 is larger than the cut level difference Rδc 2, the difference between them is not limited. For example, the difference between the cut level difference Rδc1 and the cut level difference Rδc2 may be 0.2 μm or more. With a difference between the cut level difference Rδc1 and the cut level difference Rδc2 of 0.2 μm or more in this manner, the inner wall surfaces 12e and 12f can be further uneven than the inner wall surfaces 11e, 11f, 11g and 11h of the side walls of the distal end portion 11. Since the inner wall surface 12e and the inner wall surface 12f have even smaller contact angles with respect to the test liquid, bubbles having large curvatures are less likely to adhere to the inner wall surface 12e and the inner wall surface 12f, and the measurement accuracy of the test liquid can be improved. In addition, cleaning the inner wall surface 12e of the first sidewall 12a and the inner wall surface 12f of the second sidewall 12b, which are difficult to clean, with pure water or the like improves the cleaning efficiency.

The cut level difference Rδc2 is, for example, 0.2 μm or less. With the cut level difference Rδc2 of 0.2 μm or less, the contact angles of the inner wall surfaces 11e, 11f, 11g, and 11h of the distal end portion 11 with respect to the test liquid are further increased, and thus the effect of controlling the wetting-up of the test liquid toward the end surface of the distal end portion 11 is enhanced. When a plurality of liquid housing containers are adjacent to each other, cross-contamination of the test liquid between the liquid housing containers is controlled, and the measurement accuracy of the test liquid can be improved.

An arithmetic mean roughness Ra1 in the roughness curve of the inner wall surface 12e of the first sidewall 12a and the inner wall surface 12f of the second sidewall 12b is larger than an arithmetic mean roughness Ra2 in the roughness curve of the inner wall surfaces 11e, 11f, 11g, and 11h of the sidewalls of the distal end portion 11. With such a configuration, the inner wall surface 12e and the inner wall surface 12f have small contact angles with respect to the test liquid. Therefore, bubbles having large curvatures are less likely to adhere than the inner wall surfaces 11e, 11f, 11g, and 11h, and thus the measurement accuracy of the test liquid can be further improved. On the other hand, the inner wall surfaces 11e, 11f, 11g, and 11h of the side walls of the distal end portion 11 have large contact angles with respect to the test liquid, and thus the wetting-up of the test liquid toward the end surface of the distal end portion 11 is further controlled. Therefore, when a plurality of liquid housing containers are adjacent to each other, cross-contamination of the test liquid between the liquid housing containers is controlled, and the measurement accuracy of the test liquid can be further improved. Specifically, the difference between the arithmetic mean roughness Ra1 and the arithmetic mean roughness Ra2 may be 0.1 μm or more.

The arithmetic mean roughness Ra2 is, for example, 0.2 μm or less. With the arithmetic mean roughness Ra2 of 0.2 μm or less, the contact angles of the inner wall surfaces 11e, 11f, 11g, and 11h of the distal end portion 11 with respect to the test liquid are further increased, and thus the effect of controlling the wetting-up of the test liquid toward the end surface of the distal end portion 11 is enhanced. When a plurality of liquid housing containers are adjacent to each other, cross-contamination of the test liquid between the liquid housing containers is controlled, and the measurement accuracy of the test liquid can be improved.

In the liquid housing container 10 illustrated in FIGS. 4 and 5, the cut level difference Rδc1 in the roughness curve of the inner wall surface 12e of the first sidewall 12a and the inner wall surface 12f of the second sidewall 12b is larger than the cut level difference Rδc3 in the roughness curve of the inner wall surface 12g of the third sidewall 12c and the inner wall surface 12h of the fourth sidewall 12d. With such a configuration, the inner wall surface 12e and the inner wall surface 12f have small contact angles with respect to the test liquid. Therefore, bubbles having large curvatures are less likely to adhere to the inner wall surface 12e and the inner wall surface 12f, and thus the measurement accuracy of the test liquid can be improved. On the other hand, the inner wall surface 12g and the inner wall surface 12h have large contact angles with respect to the test liquid, and thus wetting-up of the test liquid toward the end surface, on the opening side, connecting to the inner wall surface 12g and the inner wall surface 12h is controlled. Therefore, when adjacent liquid housing containers are adjacent to the third sidewall 12c or the fourth sidewall 12d, cross-contamination of the test liquid between the liquid housing containers is controlled, and the measurement accuracy of the test liquid can be improved.

As long as the cut level difference Rδc 1 is larger than the cut level difference Rδc 3, the difference between them is not limited. For example, the difference between the cut level difference Rδc1 and the cut level difference Rδc3 may be 0.2 μm or more. With a difference between the cut level difference Rδc1 and the cut level difference Rδc3 of 0.2 μm or more in this manner, the inner wall surfaces 12e and 12f can be further uneven than the inner wall surfaces 12g and 12h. Since the inner wall surface 12e and the inner wall surface 12f have even smaller contact angles with respect to the test liquid, bubbles having large curvatures are less likely to adhere to the inner wall surface 12e and the inner wall surface 12f, and the measurement accuracy of the test liquid can be improved. In addition, cleaning the inner wall surface 12e, which is difficult to clean, with pure water or the like improves the cleaning efficiency.

The cut level difference Rδc3 is, for example, 0.2 μm or less. With the cut level difference Rδc3 of 0.2 μm or less, the contact angles of the inner wall surfaces 12g and 12h with respect to the test liquid are further increased, and thus the effect of controlling the wetting-up of the test liquid toward the end surface of the distal end portion 11 is enhanced. When a plurality of liquid housing containers are adjacent to each other, cross-contamination of the test liquid between the liquid housing containers is controlled, and the measurement accuracy of the test liquid can be improved.

The arithmetic mean roughness Ra1 in the roughness curve of the inner wall surface 12e of the first sidewall 12a and the inner wall surface 12f of the second sidewall 12b is larger than an arithmetic mean roughness Ra3 in the roughness curve of the inner wall surface 12g of the third sidewall 12c and the inner wall surface 12h of the fourth sidewall 12d. With such a configuration, the inner wall surface 12e and the inner wall surface 12f have small contact angles with respect to the test liquid. Therefore, bubbles having large curvatures are even less likely to adhere to the inner wall surface 12g and the inner wall surface 12h, and thus the measurement accuracy of the test liquid can be further improved. On the other hand, the inner wall surface 12g and the inner wall surface 12h have large contact angles with respect to the test liquid, and thus the wetting-up of the test liquid toward the end surface of the distal end portion 11 is further controlled. Therefore, when adjacent liquid housing containers are adjacent to the third sidewall 12c or the fourth sidewall 12d, cross-contamination of the test liquid between the liquid housing containers is controlled, and the measurement accuracy of the test liquid can be further improved.

Specifically, the difference between the arithmetic mean roughness Ra1 and the arithmetic mean roughness Ra3 may be 0.2 μm or more. The arithmetic mean roughness Ra3 is, for example, 0.1 μm or less.

The cut level difference Rδc1, the cut level difference Rδc2, the cut level difference Rδc3, the arithmetic mean roughness Ra1, the arithmetic mean roughness Ra2, and the arithmetic mean roughness Ra3 can be measured in accordance with JIS B 0601:2001 using a laser microscope (an ultra-deep color 3D shape measuring microscope (VK-X1100 or successor models thereof) available from Keyence Corporation). A line roughness may be measured under measurement conditions in which: a coaxial vertical illumination is used for illumination; a measurement magnification is set to 120×; there is no cutoff value λs; a cutoff value λc is set to 0.08 mm; correction of termination effect is enabled; two locations are selected from each of the inner wall surfaces 11e, 11f, 11g, 11h, 12e, 12f, 12g and 12h to be measured, and a measurement range per location is set to 2792 μm×2090 μm; and for each measurement range, four lines to be measured are drawn along a longitudinal direction of the measurement range. The length per line serving as the measurement target is, for example, 2640 μm.

The cut level difference Rδc1, the cut level difference Rδc2, the cut level difference Rδc3, the arithmetic mean roughness Ra1, the arithmetic mean roughness Ra2, and the arithmetic mean roughness Ra3 for each line in each measurement range may be obtained, mean values may be calculated for each inner wall surface, and the mean values may be compared.

At least one of the inner wall surface 12g of the third sidewall 12c or the inner wall surface 12h of the fourth sidewall 12d may have a lightness index L* in the CIE 1976 L*a*b* color space of not less than 83.2 and not more than 85.1, and chromaticity indices a* and b* of not less than −0.2 and not more than 0.2 and not less than −0.3 and not more than 2.3, respectively.

When the lightness index L*, the chromaticity indices a* and b* are all within the above ranges, the inner portion of the sidewall is not seen through and exhibits a white color. Therefore, dirt adhering to the inner wall surface 12g or the inner wall surface 12h can be easily found, and cleaning or replacement can be easily performed. Moreover, since it is a color that conveys a sense of cleanliness, the white color can provide a highly aesthetic appearance.

The lightness index L*, the chromaticity indices a* and b* in the CIE 1976 L*a*b* color space of the inner wall surfaces 12g and 12h may be measured in accordance with JIS Z 8722:2009. The measurement may be performed using a chromatic colorimeter (CR-221 available from the former Minolta Co., Ltd.) where the reference light source is D65, the illumination receiving method is a condition a((45−n)[45−0]), and the measurement diameter is set to 3 mm.

At least one of the third sidewall 12c or the fourth sidewall 12d may has a visible light transmittance of 15% or less. With the visible light transmittance in this range, the inner portion of the sidewall is less likely to be seen through even when the sidewall is as thin as 0.8 mm, so that the influence of disturbance on the light for measurement introduced from the first sidewall 12a is controlled, and the measurement accuracy of the test liquid can be improved.

The transmittance may be measured with the third sidewall 12c (fourth sidewall 12d) having a thickness of 1.0 mm as a sample for measurement in accordance with JIS Z 8722-2000 by using a spectrophotometric colorimeter (such as CM-3700d available from KONICA MINOLTA, INC.) where the reference light source is D65, the wavelength range is from 360 to 740 nm, and the viewing angle is 10°, and by using a mask (LAV) having a measurement diameter of φ25.4 mm and an irradiation diameter of φ28 mm.

The method of manufacturing the liquid housing container according to the embodiments of the present disclosure is not limited. When a ceramic is used as a material for the distal end portion, the tubular portion, and the base portion, the liquid housing container illustrated in FIG. 1 is obtained, for example, through the following procedure.

A case will be described where the distal end portion, the third sidewall and the fourth sidewall of the tubular portion, and the base portion are made of a ceramic containing aluminum oxide as a main component. Aluminum oxide powder (having a purity of 99.9 mass % or more), which is a main component, and each powder of magnesium hydroxide, silicon oxide, and calcium carbonate are put into a pulverizing mill together with a solvent (ion-exchanged water), and are ground until an average particle diameter (D50) of the powder is 1.5 μm or less. Then an organic binder and a dispersing agent for dispersing the aluminum oxide powder are added and mixed to obtain a slurry. Here, of the total of 100 mass % of the powder described above, the content of magnesium hydroxide powder falls in a range of 0.3 to 0.42 mass %; the content of silicon oxide powder falls in a range of 0.5 to 0.8 mass %; the content of calcium carbonate powder falls in a range of 0.060 to 0.1 mass %; and the remainder includes aluminum oxide powder and inevitable impurities.

The organic binder is an acrylic emulsion, polyvinyl alcohol, polyethylene glycol, polyethylene oxide, or the like. The slurry is then spray-granulated to obtain granules. When obtaining the tubular portion, the granules are filled into a molding die. Then, pressure is applied to the granules with the molding pressure set to not less than 78 MPa and not more than 128 MPa to obtain frame-like and plate-like powder compacts. These powder compacts can be held at a temperature of not less than 1500° C. and not more than 1700° C. for a period of time of not less than four hours and not more than six hours to obtain frame-like and plate-like sintered bodies.

A case will be described where the distal end portion, the third sidewall and the fourth sidewall of the tubular portion, and the base portion are made of a ceramic containing zirconium oxide as a main component.

First, powder of zirconium oxide produced by a coprecipitation method is prepared in which the amount of yttrium oxide added as a stabilizer is not less than 1 mol % and less than 3 mol %. In order that the inner wall surface of at least one of the third sidewall or the fourth sidewall has the lightness index L* in the CIE 1976 L*a*b* color space of not less than 83.2 and not more than 85.1 and the chromaticity indices a* and b* of not less than −0.2 and not more than 0.2 and not less than −0.3 and not more than 2.3, respectively, for example, not less than 0.3 part by mass and not more than 5.0 parts by mass of aluminum oxide powder as a colorant is added to and mixed with 100 parts by mass of zirconium oxide powder, and then water as a solvent is added thereto, followed by mixing and grinding with a vibration mill, a ball mill, or the like.

In order to set the visible light transmittance of at least one of the third sidewall or the fourth sidewall to 15% or less, the amount of the aluminum oxide powder may be not less than 3.0 parts by mass and not more than 5.0 parts by mass with respect to 100 parts by mass of the zirconium oxide powder.

Here, the average particle diameter of the zirconium oxide powder may be not less than 0.05 μm and less than 0.5 μm and the average particle diameter of the aluminum oxide may be not less than 0.5 μm and not more than 2.0 μm. Making the average particle diameter of the aluminum oxide as a colorant larger than the average particle diameter of the zirconium oxide as the main component in this manner causes a disintegration action of the aluminum oxide, and can control aggregation of the zirconium oxide.

For a ball used for mixing and grinding, a white ceramic ball made of zirconium oxide, a white ceramic ball made of aluminum oxide, or a white ceramic ball made of zirconium oxide and aluminum oxide may be used. For the ceramic ball, for example, a ceramic ball made of from 91 to 99 mol % of zirconium oxide (ZrO₂) having a purity of 99.5 mass % or more and from 1 to 9 mol % of at least one type of stabilizer selected from the group consisting of yttrium oxide (Y₂O₃), hafnium oxide (HfO₂), cerium oxide (CeO₂), magnesium oxide (MgO), and calcium oxide (CaO), a ceramic ball obtained by further adding, to such a composition, from 1 to 40 mass % of aluminum oxide (Al₂O₃) having a purity of 99.5 mass % or more, or a ceramic ball made only of aluminum oxide having a purity of 99.5 mass % or more may be used.

Predetermined amounts of various binders are added to the mixed and ground powder, and dried by a spray dry method to form granules. After the granules are filled into the molding die, pressure is applied to the granules with the molding pressure set to not less than 78 MPa and not more than 128 MPa to obtain frame-like and plate-like powder compacts. After being degreased as necessary, the obtained powder compacts are fired at a temperature of not less than 1350° C. and not more than 1550° C. in an air atmosphere to obtain frame-like and plate-like sintered bodies. The frame-like sintered body is subjected to buffing, magnetic fluid polishing, or the like to form an inner wall surface such that the cut level difference Rδc2 is smaller than the cut level difference Rδc1. Before buffing or magnetic fluid polishing, the inner wall of the sintered body may be ground. When buffing, for example, the inner wall of the sintered body may be polished with diamond paste applied to a buff. The diamond paste is, for example, a paste in which diamond abrasive grains having an average particle diameter D₅₀ of not less than 1 μm and not more than 10 μm are dispersed in an organic solvent. The base material of the buff is, for example, felt.

Some of the plate-like sintered bodies are diffusion bonded, together with flat plates made of sapphire, to the sintered bodies to be the distal end portion and the base portion, thereby forming the third sidewall and the fourth sidewall. The flat plates made of sapphire are diffusion bonded to the sintered bodies to be the distal end portion and the base portion, thereby forming the first sidewall and the second sidewall. The plate-like sintered body other than those forming the third sidewall and the fourth sidewall forms the base portion.

The plate-like sintered bodies to be the third sidewall and the fourth sidewall and the sapphire flat plates to be the first sidewall and the second sidewall may be subjected to lapping polishing before diffusion bonding to form the inner wall surface. The sapphire flat plates may be subjected to lapping polishing to form the outer wall surface. Inner wall surfaces and outer wall surfaces having high light transmissivity can be obtained by lapping polishing. When polishing the sapphire flat plates to be the first sidewall and the second sidewall, slurry containing diamond abrasive grains having a large average particle diameter, for example an average particle diameter (D₅₀) of from 20 μm to 30 μm, may be supplied to a lapping machine made of cast iron at predetermined time intervals to polish, with a focus on polishing efficiency. However, when the sapphire flat plates are polished with diamond abrasive grains having an average particle diameter (D₅₀) in this range, light transmissivity cannot be achieved. Therefore, thermal treatment may be performed after polishing and cleaning.

For thermal treatment, after the polished and cleaned sapphire flat plates were placed at a predetermined position in a furnace, the temperature in the furnace was raised to 1950° C. over 14 hours in an argon gas atmosphere, and this state was held for about five hours. Holding at this temperature is followed by cooling to room temperature over six hours or more.

Here, before diffusion bonding the respective sites, water is first caused to adhere to at least one of a first opposing surface facing the tubular portion of the distal end portion or a second opposing surface facing the distal end portion of the tubular portion, and at least one of a third opposing surface facing the base portion of the tubular portion or a fourth opposing surface facing the tubular portion of the base portion.

The method of adhering water is not limited. Examples of the method include spraying water onto at least one of the first opposing surface or the second opposing surface and at least one of the third opposing surface or the fourth opposing surface, applying water using a brush or the like, and directly immersing in water. The first opposing surface, the second opposing surface, third opposing surface, and the fourth opposing surface are obtained by, for example, supplying a lapping machine made of copper, tin, or a tin-lead alloy with slurry containing diamond abrasive grains having an average particle diameter (D₅₀) of not less than 0.5 μm and not more than 3 μm, at predetermined time intervals and polishing before adhering water.

The arithmetic mean roughness Ra of each of the first opposing surface, the second opposing surface, third opposing surface, and the fourth opposing surface is, for example, 0.2 μm or less.

Note that the first opposing surface, the second opposing surface, third opposing surface, and the fourth opposing surface are also obtained by grinding instead of polishing.

After water is caused to adhere, the first opposing surface and the second opposing surface are made to face each other and adsorbed if necessary, and the third opposing surface and the fourth opposing surface are made to face each other and adsorbed if necessary. Then, diffusion bonding is performed by performing thermal treatment while pressing these opposing surfaces. The strength of the pressing is not limited, and is set appropriately in accordance with the size, material, or the like of the tubular portion 12 or the base portion 13. Specifically, they may be pressed by a pressure of approximately 1 kgf to 5 kgf. If necessary, the first sidewall, the second sidewall, the third sidewall, and the fourth sidewall may be diffusion-bonded, by pressing in the thickness direction of the third sidewall and the fourth sidewall, to form the tubular portion.

The thermal treatment is set appropriately in accordance with the size, material, or the like of the distal end portion, the tubular portion, and the base portion. Specifically, the thermal treatment can be performed at not less than 1000° C. and not more than 1800° C. The thermal treatment can be performed, for example, for approximately 30 minutes to 120 minutes. In this manner, the liquid housing container 10 according to an embodiment is manufactured.

The liquid housing container illustrated in FIGS. 2 and 3 is obtained, for example, by the following procedure. A case will be described where the distal end portion and the base portion are made of a ceramic containing aluminum oxide as a main component, and the tubular portion is made of sapphire.

The manufacturing method for the distal end portion and the base portion is the same as the manufacturing method for the liquid housing container illustrated in FIG. 1. For the tubular portion, a rectangular tubular body of sapphire can be obtained by an edge-defined film-fed growth (EFG) method, for example.

The rectangular tubular body of sapphire may be subjected to buffing, magnetic fluid polishing, or the like before diffusion bonding to form an inner wall surface. The rectangular tubular body of sapphire may be further subjected to lapping polishing to form an outer wall surface. By such polishing, an inner wall surface and an outer wall surface having high light transmissivity can be obtained.

The diffusion bonding is performed by the above-described manufacturing method, and the liquid housing container illustrated in FIGS. 2 and 3 can be obtained.

In order to obtain the liquid housing container illustrated in FIGS. 4 and 5, the distal end portion may be removed from the above-described manufacturing method. Here, when forming each inner wall surface by lapping polishing using diamond abrasive grains, the average particle diameter of the diamond abrasive grains used for the lapping polishing of the first sidewall and the second sidewall may be smaller than the average particle diameter of the diamond abrasive grains used for the lapping polishing of the third sidewall and the fourth sidewall.

Selecting the average particle diameter of the diamond abrasive grains in this manner allows an inner wall surface to be obtained in which the cut level difference Rδc3 is smaller than the cut level difference Rδc1.

Hereinafter, examples of the present disclosure will be specifically described; however, the present disclosure is not limited to these examples.

### Example 1

In order to obtain the liquid housing container 10 illustrated in FIG. 1, first, a frame-like sintered body made of a ceramic containing aluminum oxide as a main component was prepared. After grinding the inner wall of the sintered body, the inner wall surfaces 11e, 11f, 11g, and 11h were formed by buffing using a paste in which diamond abrasive grains having an average particle diameter (D₅₀) shown in Table 1 were dispersed in organic solvent.

After preparing sapphire flat plates, a slurry containing diamond abrasive grains having an average particle diameter (D₅₀) shown in Table 1 was supplied to a lapping machine made of cast iron to polish main surfaces on both sides.

For thermal treatment, after the polished and cleaned sapphire flat plates were placed at a predetermined position in a furnace, the temperature in the furnace was raised to 1950° C. over 14 hours in an argon gas atmosphere, and this state was held for five hours. Holding at this temperature was followed by cooling to room temperature over six hours or more, whereby a first partition wall 12a and a second partition wall 12b before diffusion bonding were produced.

Plate-like sintered bodies containing aluminum oxide as a main component were prepared, and main surfaces on both sides were ground to produce a third partition wall 12c and a fourth partition wall 12d before diffusion bonding.

Slurry containing diamond abrasive grains having an average particle diameter (D₅₀) of 2 μm was supplied to a lapping machine made of tin at predetermined time intervals to polish the first opposing surface facing the tubular portion 12 of the distal end portion 11, the second opposing surface facing the distal end portion 11 of the tubular portion 12, the third opposing surface facing the base portion 13 of the tubular portion 12, and the fourth opposing surface facing the tubular portion 12 of the base portion 13.

After water is caused to adhere to each of the first opposing surface facing the tubular portion 12 of the distal end portion 11 and the fourth opposing surface facing the tubular portion 12 of the base portion 13, the first opposing surface and the second opposing surface were caused to face each other and adsorbed, and the third opposing surface and the fourth opposing surface were caused to face each other and adsorbed. Then, the liquid housing container illustrated in FIG. 1 was obtained by performing thermal treatment at a temperature of 1400° C. for 60 minutes while pressing these opposing surfaces.

After the tubular portion 12 was separated from the distal end portion 11 and the base portion 13 by cutting, the first sidewall 12a, the second sidewall 12b, the third sidewall 12c, and the fourth sidewall 12d were cut off The sidewalls 11a, 11b, 11c, and 11d of the distal end portion 11 were also cut off from each other.

Each of the cut level difference Rδc1 of the inner wall surface 12e of the first sidewall 12a and the cut level difference Rδc2 of the inner wall surface 11e of the sidewall 11a of the distal end portion 11 was measured, and the difference ΔRδc=Rδc1−Rδc2 was calculated.

The cut level difference Rδc1 and the cut level difference Rδc2 were measured in accordance with JIS B 0601:2001 using a laser microscope (an ultra-deep color 3D shape measuring microscope (VK-X1100) available from Keyence Corporation). A line roughness was measured under measurement conditions in which: a coaxial vertical illumination is used for illumination: a measurement magnification is set to 120×; there is no cutoff value λs; a cutoff value λc is set to 0.08 mm; correction of termination effect is enabled; two locations are selected from each of the inner wall surfaces 11e and 12e to be measured, and a measurement range per location is set to 2792 μm×2090 μm; and for each measurement range, four lines to be measured are drawn along a longitudinal direction of the measurement range. The length per line serving as the measurement target is 2640 μm.

Respective static contact angles of the inner wall surface 12e and the inner wall surface 11e with respect to pure water were measured. The static contact angles were obtained under the following measurement conditions using a surface contact angle measuring device “CA-X type” (available from Kyowa Interface Science Co., Ltd.).
Droplet amount of pure water: 1 mm³
Holding time: 5 seconds Note that since the inner wall surface 12f of the second sidewall 12b is obtained by the same manufacturing history as that of the inner wall surface 12e of the first sidewall 12a, the cut level difference Rδc1 and the static contact angle are represented by the inner wall surface 12e of the first sidewall 12a.

Table 1 shows the values of the cut level difference Rδc1, the cut level difference Rδc2, the difference ΔRδc, and the static contact angle.

TABLE 1

| | | | AVERAGE PARTICLE | | | | | | |
|---|---|---|---|---|---|---|---|---|---|
| | | | DIAMETER (D₅₀) OF | | Cut level | Cut level | | | |
| | MAIN COMPONENT | | ABRASIVE GRAINS (μm) | | difference | difference | | Static contact | Static contact |
| | First | | For polishing | For polishing | Rδc1 of | Rδc2 of | | angle of inner | angle of inner |
| | sidewall 12a | | inner wall | inner wall | inner wall | inner wall | | wall surface 12e | wall surface 11e |
| | and second | Distal end | surfaces 12e | surfaces 11e, | surface | surface | ΔRδc | with respect to | with respect to |
| No. | sidewall 12b | portion 11 | and 12f | 11f, 11g, and 11h | 12e (μm) | 11e (μm) | (μm) | test liquid (°) | test liquid (°) |
| 1 | SAPPHIRE | ALUMINUM | 20 | 20 | 0.318 | 0.324 | −0.006 | 32 | 32 |
| | | OXIDE | | | | | | | |
| 2 | SAPPHIRE | ALUMINUM | 20 | 10 | 0.321 | 0.218 | 0.103 | 32 | 86 |
| | | OXIDE | | | | | | | |
| | SAPPHIRE | ALUMINUM | 20 | 5 | 0.319 | 0.2 | 0.119 | 32 | 90 |
| | | OXIDE | | | | | | | |
| 4 | SAPPHIRE | ALUMINUM | 22.5 | 3 | 0.344 | 0.144 | 0.2 | 30 | 92 |
| | | OXIDE | | | | | | | |
| 5 | SAPPHIRE | ALUMINUM | 25 | 3 | 0.362 | 0.144 | 0.218 | 28 | 93 |
| | | OXIDE | | | | | | | |
| 6 | SAPPHIRE | ALUMINUM | 30 | 1 | 0.381 | 0.084 | 0.297 | 26 | 94 |
| | | OXIDE | | | | | | | |

As can be seen from Table 1, for sample Nos. 2 to 6, the cut level difference Rδc1 of the inner wall surface 12e is larger than the cut level difference Rδc2 of the inner wall surface 11e, and thus the static contact angle of the inner wall surface 12e is smaller than the static contact angle of the inner wall surface 11e. As a result, it can be said that bubbles having large curvatures are less likely to adhere to the inner wall surface 12e, and the measurement accuracy of the test liquid can be improved.

In particular, for sample Nos. 3 to 6, the cut level difference Rδc2 is 0.2 μm or less, and thus the effect of controlling the wetting-up of the test liquid toward the end surface of the distal end portion 11 is enhanced. Therefore, it can be said that, when a plurality of liquid housing containers are adjacent to each other, cross-contamination of the test liquid between the liquid housing containers is controlled, and the measurement accuracy of the test liquid can be improved.

For sample Nos. 4 to 6, the difference ΔRδc is 0.2 μm or more, and thus the inner wall surface 12e has an even smaller static contact angle with respect to the test liquid. Therefore, it can be said that bubbles having large curvatures are less likely to adhere to the inner wall surface 12e, and the measurement accuracy of the test liquid can be improved. In addition, cleaning the inner wall surface 12e, which is difficult to clean, with pure water or the like improves the cleaning efficiency.

### Example 2

In order to obtain the liquid housing container 10 illustrated in FIG. 3, a distal end portion before diffusion bonding was produced using the same method as the method of producing the distal end portion of the sample No. 2 of Example 1.

After preparing the sapphire flat plates, a slurry containing diamond abrasive grains having an average particle diameter (D₅₀) shown in Table 2 was supplied to a lapping machine made of cast iron to polish main surfaces on both sides.

The polished and cleaned sapphire plates were subjected to thermal treatment by the same method as the method shown in Example 1. After grinding the main surfaces on both sides of the plate-like sintered bodies containing aluminum oxide as a main component, a slurry containing diamond abrasive grains having an average particle diameter (D₅₀) shown in Table 2 was supplied to a lapping machine made of a bell-lead alloy to polish the ground main surfaces on both sides.

The first opposing surface, the second opposing surface, the third opposing surface, and the fourth opposing surface were polished by the same method as the method shown in Example 1. The liquid housing container illustrated in FIG. 3 was obtained by performing adsorption and thermal treatment by the same method as the method shown in Example 1.

The cut level difference Rδc1, the cut level difference Rδc3, the difference (ΔRδc=Rδc1−Rδc3), and the static contact angle were obtained by the same method as the method shown in Example 1 These values are shown in Table 2.

TABLE 2

| [symbol] | Cut level | Cut level | | Static contact angle | Static contact angle |
|---|---|---|---|---|---|
| [symbol] | difference Rδc1 of | difference Rδc3 of | | of inner wall surface | of inner wall surface |
| [symbol] | inner wall surface | inner wall surface | ΔRδc | 12e with respect to | 12g with respect to |
| [symbol] | 12e (μm) | 12g (μm) | (μm) | test liquid (°) | test liquid (°) |
| [symbol] | 0.318 | 0.322 | −0.004 | 32 | 30 |
| [symbol] | 0.321 | 0.216 | 0.105 | 32 | 86 |
| [symbol] | 0.319 | 0.2 | 0.119 | 32 | 90 |

[symbol]

indicates data missing or illegible when filed

As can be seen from Table 2, for sample Nos. 8 to 12, the cut level difference Rδc1 of the inner wall surface 12e is larger than the cut level difference Rδc3 of the inner wall surface 12g, and thus the static contact angle of the inner wall surface 12e is smaller than the static contact angle of the inner wall surface 12g. As a result, it can be said that bubbles having large curvatures are less likely to adhere to the inner wall surface 12e, and the measurement accuracy of the test liquid can be improved. On the other hand, since wetting-up of the test liquid toward the end surface, on the opening side, connecting to the inner wall surface 12g is controlled, it can be said that, when adjacent liquid housing containers are adjacent to the third sidewall 12c, cross-contamination of the test liquid between the liquid housing containers is controlled, and the measurement accuracy of the test liquid can be improved.

In particular, for sample Nos. 9 to 12, the cut level difference Rδc3 is 0.2 μm or less, and thus the effect of controlling the wetting-up of the test liquid toward the end surface of the distal end portion 11 from the inner wall surface 12g is enhanced. Therefore, it can be said that, when a plurality of liquid housing containers are adjacent to each other, cross-contamination of the test liquid between the liquid housing containers is controlled, and the measurement accuracy of the test liquid can be improved.

For sample Nos. 10 to 12, the difference ΔRδc is 0.2 μm or more, and thus the inner wall surface 12e has an even smaller static contact angle with respect to the test liquid. Therefore, it can be said that bubbles having large curvatures are less likely to adhere to the inner wall surface 12e, and the measurement accuracy of the test liquid can be improved. In addition, cleaning the inner wall surface 12e, which is difficult to clean, with pure water or the like improves the cleaning efficiency.

### REFERENCE SIGNS

10 Liquid housing container
11 Distal end portion
11e to 11h Inner wall surface
12 Tubular portion
12a First sidewall
12b Second sidewall
12c Third sidewall
12d Fourth sidewall
12e to 12h Inner wall surface
13 Base portion
13a Inner bottom surface

1. A liquid housing container comprising:
a distal end portion that is frame-like;
a tubular portion comprising
a first sidewall configured to introduce light for measurement,
a second sidewall configured to guide the light outward, and
a third sidewall and a fourth sidewall located between the first sidewall and the second sidewall and connecting the first sidewall and the second sidewall, the tubular portion being connected to the distal end portion on a bottom side of the distal end portion; and
a base portion sealing a bottom side of the tubular portion, wherein
a cut level difference is a difference between a cut level at a load length ratio of 25% in a roughness curve and a cut level at a load length ratio of 75% in the roughness curve, and
a cut level difference Rδc1 in a roughness curve of an inner wall surface of the first sidewall and an inner wall surface of the second sidewall is larger than a cut level difference Rδc2 in a roughness curve of an inner wall surface of a sidewall of the distal end portion.

2. The liquid housing container according to claim 1, wherein
the cut level difference Rδc2 is 0.2 μm or less.

3. The liquid housing container according to claim 1, wherein
a difference between the cut level difference Rδc1 and the cut level difference Rδc2 is 0.2 μm or more.

4. The liquid housing container according to claim 1, wherein
an arithmetic mean roughness Ra1 in the roughness curve of the inner wall surface of the first sidewall and the inner wall surface of the second sidewall is larger than an arithmetic mean roughness Ra2 in the roughness curve of the inner wall surface of the sidewall of the distal end portion.

5. A liquid housing container comprising:
a distal end portion
a tubular portion comprising
a first sidewall configured to introduce light for measurement,
a second sidewall configured to guide the light outward, and
a third sidewall and a fourth sidewall located between the first sidewall and the second sidewall and connecting the first sidewall and the second sidewall, the tubular portion being connected to the distal end portion on a bottom side of the distal end portion; and
a base portion sealing a bottom side of the tubular portion, wherein
a cut level difference is a difference between a cut level at a load length ratio of 25% in a roughness curve and a cut level at a load length ratio of 75% in the roughness curve, and a cut level difference Rδc1 in a roughness curve of an inner wall surface of the first sidewall and an inner wall surface of the second sidewall is larger than a cut level difference Rδc3 in a roughness curve of an inner wall surface of the third sidewall and an inner wall surface of the fourth sidewall.

6. The liquid housing container according to claim 5, wherein
the cut level difference Rδc3 is 0.2 μm or less.

7. The liquid housing container according to claim 5, wherein
a difference between the cut level difference Rδc1 and the cut level difference Rδc3 is 0.2 μm or more.

8. The liquid housing container according to claim 5, wherein
an arithmetic mean roughness Ra1 in the roughness curve of the inner wall surface of the first sidewall and the inner wall surface of the second sidewall is larger than an arithmetic mean roughness Ra3 in the roughness curve of the inner wall surface of the third sidewall and the inner wall surface of the fourth sidewall.

9. The liquid housing container according to claim 1, wherein
at least one of the first sidewall, the second sidewall, the third sidewall, or the fourth sidewall has an inclination toward an inner bottom surface of the base portion.

10. The liquid housing container according to claim 9, wherein
the inclination has a rounded shape.

11. The liquid housing container according to claim 1, wherein
the tubular portion comprises a first ceramic, and the base portion comprises a second ceramic.

12. The liquid housing container according to claim 1, wherein
a space formed by the tubular portion and the base portion is a space in which a reagent and a sample react with each other.

13. The liquid housing container according to claim 1, wherein
at least one inner wall surface of the third sidewall or an inner wall surface of the fourth sidewall has a lightness index L* in a CIE 1976 L*a*b* color space of not less than 83.2 and not more than 85.1, and chromaticity indices a* and b* of not less than −0.2 and not more than 0.2 and not less than −0.3 and not more than 2.3, respectively.

14. The liquid housing container according to claim 1, wherein
at least one of the third sidewall or the fourth sidewall has a visible light transmittance of 15% or less.

15. A manufacturing method for the liquid housing container according to claim 1, the manufacturing method comprising:
adhering water to at least one of a first opposing surface facing the tubular portion of the distal end portion or a second opposing surface facing the distal end portion of the tubular portion, and at least one of a third opposing surface facing the base portion of the tubular portion or a fourth opposing surface facing the tubular portion of the base portion, respectively;
causing the first opposing surface and the second opposing surface to face each other, and the third opposing surface and the fourth opposing surface to face each other; and
applying pressure from a longitudinal direction and performing thermal treatment.

16. The manufacturing method for the liquid housing container according to claim 15, the manufacturing method further comprising before applying the pressure and performing the thermal treatment, grinding or polishing at least one of the first opposing surface or the second opposing surface, the third opposing surface, and the fourth opposing surface.

17. A manufacturing method for the liquid housing container according to claim 5, the manufacturing method comprising:
adhering water to at least one of a third opposing surface facing the base portion of the tubular portion or a fourth opposing surface facing the tubular portion of the base portion;
causing the third opposing surface and the fourth opposing surface to face each other; and
applying pressure from a longitudinal direction and performing thermal treatment.

18. The manufacturing method for the liquid housing container according to claim 15, the manufacturing method further comprising
before applying the pressure and performing the thermal treatment, grinding or polishing at least one of the first opposing surface or the second opposing surface, the third opposing surface, and the fourth opposing surface.
